(19) United States
(12) Patent Application Publication
(10) Pub. No.: US 2022/0030640 A1
(43) Pub. Date: Jan. 27, 2022

(54) USER EQUIPMENT AND METHOD FOR A RANDOM ACCESS CHANNEL PROCEDURE OF SAME

(71) Applicant: Guangdong Oppo Mobile Telecommunications Corp., Ltd., Dongguan (CN)

(72) Inventor: Yongsheng Shi, Palo Alto, CA (US)

(73) Assignee: Guangdong Oppo Mobile Telecommunications Corp., Ltd., Dongguan (CN)

(21) Appl. No.: 17/493,040

(22) Filed: Oct. 4, 2021

Related U.S. Application Data
(63) Continuation of application No. PCT/CN2019/115014, filed on Nov. 1, 2019.
(60) Provisional application No. 62/829,508, filed on Apr. 4, 2019.

(51) Int. Cl. H04W 74/08; H04W 52/36; H04W 52/14

(52) U.S. Cl. CPC H04W 74/0841; H04W 52/146; H04W 52/36

(57) ABSTRACT

A user equipment (UE) and a method for a random access channel (RACH) procedure of same are provided. The method includes initiating a two-step RACH procedure, transmitting a message associated with the two-step RACH procedure, and selecting to switch from the two-step RACH procedure to a four-step RACH procedure, wherein the selecting is based on transmission information of the message associated with the two-step RACH procedure.

### CROSS-REFERENCE TO RELATED APPLICATION

The present application is a continuation of International Application of PCT/CN2019/115014, filed on Nov. 1, 2019, which claims priority to U.S. Patent Application No. 62/829,508, filed on Apr. 4, 2019, both of which are hereby incorporated by reference in their entireties.

### TECHNICAL FIELD

The present disclosure relates to the field of communication systems, and more particularly, to a user equipment (UE) and a method for a random access channel (RACH) procedure of same.

### BACKGROUND

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

5G/NR wireless systems target low latencies which need faster and more efficient schemes for random access. However, the four-step random access channel (RACH) procedure of LTE may not meet the low latency requirements of 5G/NR wireless systems. Therefore, a faster and more efficient RACH procedure is desired.

Therefore, there is a need for a user equipment (UE) and a method for a faster and more efficient RACH procedure of same.

### SUMMARY

An object of the present disclosure is to propose a user equipment (UE) and a method for a faster and more efficient random access channel (RACH) procedure of same capable of providing high reliability.

In a first aspect of the present disclosure, a user equipment (UE) for a random access channel (RACH) procedure includes a memory, a transceiver, and a processor coupled to the memory and the transceiver. The processor is configured to initiate a two-step RACH procedure, control the transceiver to transmit a message associated with the two-step RACH procedure, and select to switch from the two-step RACH procedure to a four-step RACH procedure, wherein the selecting is based on transmission information of the message associated with the two-step RACH procedure.

In a second aspect of the present disclosure, a method for a random access channel (RACH) procedure of a user equipment (UE) includes initiating a two-step RACH procedure, transmitting a message associated with the two-step RACH procedure, and selecting to switch from the two-step RACH procedure to a four-step RACH procedure, wherein the selecting is based on transmission information of the message associated with the two-step RACH procedure.

In a third aspect of the present disclosure, a non-transitory machine-readable storage medium has stored thereon instructions that, when executed by a computer, cause the computer to perform the above method.

In a fourth aspect of the present disclosure, a terminal device includes a processor and a memory configured to store a computer program. The processor is configured to execute the computer program stored in the memory to perform the above method.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates an example of a four-step random access channel (RACH) procedure at a user equipment (UE) according to an embodiment of the present disclosure.

FIG. 2 illustrates an example of a two-step RACH procedure at a UE according to an embodiment of the present disclosure.

FIG. 3 is a block diagram of a UE and a network node for a RACH procedure of same according to an embodiment of the present disclosure.

FIG. 4 is a flowchart illustrating a method for a RACH procedure of a UE according to an embodiment of the present disclosure.

FIG. 5 is a block diagram of a system for wireless communication according to an embodiment of the present disclosure.

### DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

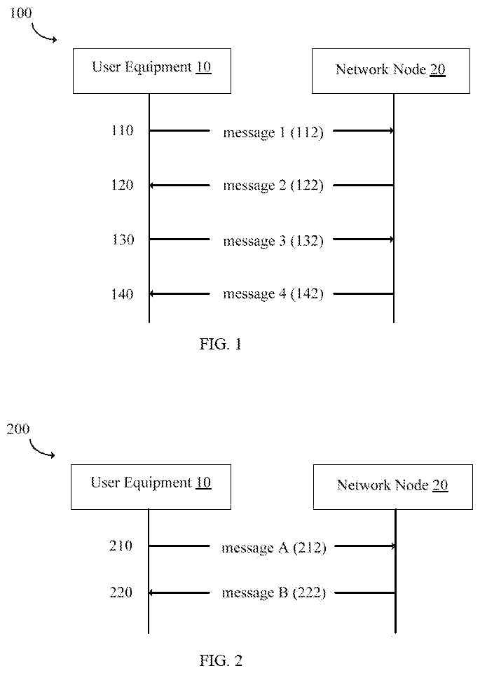

In some embodiments, FIG. 1 illustrates an example of a four-step random access channel (RACH) procedure 100 at a user equipment (UE) 10. At an operation 110, the UE 10 may transmit a message 1 (112) to a network node 20 (e.g., a base station). The UE 10 may transmit the message 1 (112) using a preamble (also referred to as a RACH preamble, a PRACH preamble, or a sequence). The UE 10 also sends an identity of the UE 10 to the network node 20, such that the network node 20 can address the UE 10 in a next operation (e.g., an operation 120). The identity used by the UE 10 may be a random access-radio network temporary identifier (RA-RNTI) which is determined from a timeslot in which the preamble (e.g., the RACH preamble, the PRACH preamble, or the sequence) is sent.

At the operation 120, the UE 10 may receive a message 2 (122) from the network node 20. The UE 10 receives the message 2 (122) in response to sending the message 1 (112) to the network node 20. The message 2 (122) may be a random access response (RAR) and received on a downlink-shared channel (DL-SCH) from the network node 20. The RAR may be addressed to the RA-RNTI calculated by the network node 20 from the timeslot in which the preamble (e.g., the RACH preamble, the PRACH preamble, or the sequence) is sent. The message 2 (122) may also carry the following information: a cell-radio network temporary identifier (C-RNTI) which may be used for further communications between the UE 10 and the network node 20, a timing advance value which informs the UE 10 to change timing of the UE 10 to compensate for a round trip delay due to a distance between the UE 10 and the network node 20, and/or uplink grant resources which may be an initial resource assigned to the UE 10 by the network node 20, such that the UE 10 can use a uplink-shared channel (UL-SCH) during an operation 130, as described below.

At the operation 130, the UE 10 may send a message 3 (132) to the network node 20.

The UE 110 sends the message 3 (132), which may be a radio resource control (RRC) connection request message, to the network node 20 in response to receiving the message 2 (122) from the network node 20. The RRC connection request message may be sent to the network node 20 using the UL-SCH based on uplink grant resources granted during the operation 320. The UE 10 may use the C-RNTI that is assigned to the UE 10 by the network node 20 during the operation 320 when sending the RRC connection request message.

The message 3 (132) or the RRC connection request message may include a UE identity, for example, a temporary mobile subscriber identity (TMSI) or a random value. The TMSI may be used for identifying the UE 10 in a core network and if the UE 10 has previously connected to the same core network. Optionally, the random value may be used if the UE 10 is connecting to the network node 20 for the first time. The message 3 (132) may also include a connection establishment which indicates a reason UE such as the UE 10 needs to connect to the network node 20.

At an operation 140, the UE 110 may receive a message 4 (142) from the network node 20. The message 4 (142) may be a contention resolution message from the network node 20 if the network node 20 successfully received and/or decoded the message 3 (132) sent from the UE 10. The network node 20 may send the message 4 (142) to the network node 20 using the TMSI value of the random number described above but may also contain a new C-RNTI which will be used for further communications between the UE 10 and the network node 20. The UE 10 uses the above described four-step RACH procedure for synchronizing with the network node 20 when establishing a connection.

In some embodiments, in the four-step RACH procedure 100, at the operation 110, the UE 10 sends the message 1 (112) (e.g., the RACH preamble) to the network node 20, at the operation 120, the network node 20 sends the message 2 (122) to the UE 10 in response to the UE 10 with a RACH response, at the operation 130, the UE 10 sends the message 3 (132) (e.g., an RRC message or medium access control (MAC) control element (CE) for contention resolution) to the network node 20, and at the operation 140, the UE 10 receives the message 4 (142) (e.g., an acknowledgement to resolve contention) from the network node 20. An example of the four-step RACH procedure 100 is illustrated in FIG. 1 when the UE 10 performs an initial registration from an idle mode.

Other than the initial registration, the four-step RACH procedure 100 is also used in many scenarios, such as a call establishment/re-establishment, a handover, a 5G beam failure recovery, an uplink (UP) scheduling request (SR) resource request, a recovery from UE-network out of synchrony with each other. Therefore, it's important to reduce RACH procedure delay.

In some embodiments, FIG. 2 illustrates an example of a two-step RACH procedure 200 at the UE 10. At an operation 210, the UE 10 may transmit a message A (212), to the network node 20. In an aspect, for example, the message 1 (112) and the message 3 (132) described above in reference to FIG. 1 above, may be collapsed (e.g., combined) into the message A (212) and sent to the network node 20. The message 1 (112) may include a preamble (also referred to as a RACH preamble, a PRACH preamble, or a sequence), and may be used a reference signal (RS) for demodulation of data transmitted in the message A (212).

At an operation 220, the UE 10 may receive a message B (222), from the network node 20. The UE 10 may receive the message B (222) in response to sending the message A (212) to the network node 20. The message B (222) may be a combination of the message 2 (122) and the message 4 (142) as described above in reference to FIG. 1.

The combining of messages 1 (112) and 3 (132) into one message A (212) and receiving of the message B (222) in response from the network node 20 allows the UE 10 to reduce RACH procedure setup time to support low-latency requirements of 5G/new radio (NR). Although, the UE 10 may be configured to support the two-step RACH procedure, the UE 10 still supports the four-step RACH procedure as a fall back as the UE 10 may not be able to relay on the two-step RACH procedure due to some constraints, e.g., high transmit power requirements, etc. Therefore, a UE in 5G/NR may be configured to support both the two-step and the four-step RACH procedures, and determines which RACH procedure to configure.

In some embodiments, the two-step RACH procedure is to reduce delay of call establishment. For the two-step RACH procedure, a number of messages exchanged between the UE 10 and the network node 20 is reduced, and thus the delay is improved. The two-step RACH procedure is to combine the message 1 and the message 3 in the four-step RACH procedure to a new message, message A, and combine the message 2 and the message 4 in the four-step RACH procedure to a new message, message B.

In some embodiments, the UE 10 can perform either the two-step RACH procedure or the four-step RACH procedure. In some embodiments, some solutions to allow the UE 10 to fall back to the four-step RACH procedure in case the message A is not received by the network node 20 are provided.

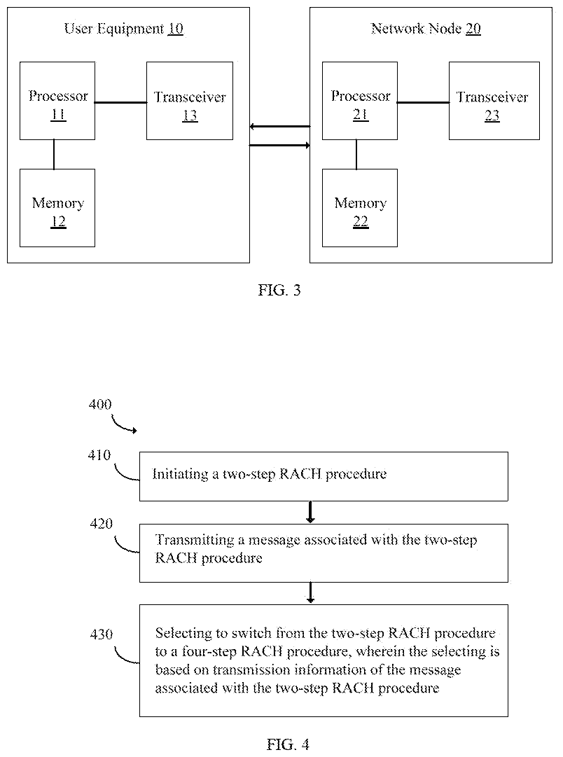

FIG. 3 illustrates that, in some embodiments, a user equipment (UE) 10 and a network node 20 for a random access channel (RACH) procedure according to an embodiment of the present disclosure are provided. The UE 10 may include a processor 11, a memory 12, and a transceiver 13. The network 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, 16, and beyond. UEs communicate with each other directly via a sidelink interface such as a PC5 interface.

In some embodiments, a RACH procedure according to an embodiment of the present disclosure can be adopted in 3rd generation partnership project (3GPP) release 14, 15, 16, and beyond. In some embodiments, the processor 11 is configured to initiate a two-step RACH procedure (e.g., the two-step RACH procedure 200 as described above in reference to FIG. 2), control the transceiver 13 to transmit a message associated with the two-step RACH procedure (e.g., the message A (212) as described above in reference to FIG. 2), and select to switch from the two-step RACH procedure to a four-step RACH procedure (e.g., the four-step RACH procedure 100 as described above in reference to FIG. 1), wherein the selecting is based on transmission information of the message associated with the two-step RACH procedure.

In some embodiments, after a maximum retransmission of the message associated with the two-step RACH procedure is reached, the processor 11 determines to switch from the two-step RACH procedure to the four-step RACH procedure. In some embodiments, the transceiver 13 is configured to receive, from the network node 20, configured different uplink transmission power transmission parameters for the two-step RACH procedure and the four-step RACH procedure respectively, and the configured different uplink transmission power transmission parameters for the two-step RACH procedure and the four-step RACH procedure include a preamble received target power and a power ramping step. In some embodiments, when the processor switches to the four-step RACH procedure, the transceiver 13 transmits a message associated with the four-step RACH procedure using an original calculated transmission power, a current transmission power, or an increased transmission power. hi some embodiments, the processor 11 is configured to calculate transmission powers of the message associated with the two-step RACH procedure and the message associated with the four-step RACH procedure separately, and the transmission powers of the message associated with the two-step RACH procedure and the message associated with the four-step RACH procedure are different.

hi some embodiments, the processor 11 is configured to select to switch from the two-step RACH procedure to the four-step RACH procedure at any time during a transmission of the message associated with the two-step RACH procedure. In some embodiments, even if a maximum retransmission of the message associated with the two-step RACH procedure is not reached, the processor 11 selects to switch from the two-step RACH procedure to the four-step RACH procedure. In some embodiments, the processor 11 is configured to select to switch from the two-step RACH procedure to the four-step RACH procedure based on a transmission power of the message associated with the two-step RACH procedure.

In some embodiments, when a maximum transmission power of the message associated with the two-step RACH procedure is reached, the processor 11 selects to switch from the two-step RACH procedure to the four-step RACH procedure. In some embodiments, the processor 11 is configured to determine to use the two-step RACH procedure or the four-step RACH procedure based on a reference signal received power (RSRP) and/or pathloss of the UE 10 or by evaluating a radio frequency (RF) condition of the UE 10.

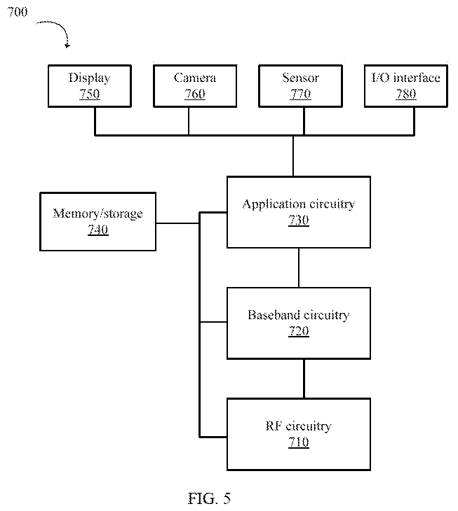

FIG. 4 illustrates a method 400 for a RACH procedure of a user equipment according to an embodiment of the present disclosure. The method 400 includes: a block 410, initiating a two-step RACH procedure (e.g., the two-step RACH procedure 200 as described above in reference to FIG. 2), a block 420, transmitting a message associated with the two-step RACH procedure (e.g., the message A (212) as described above in reference to FIG. 2), and a block 430, selecting to switch from the two-step RACH procedure to a four-step RACH procedure (e.g., the four-step RACH procedure 100 as described above in reference to FIG. 1), wherein the selecting is based on transmission information of the message associated with the two-step RACH procedure.

In some embodiments, after a maximum retransmission of the message associated with the two-step RACH procedure is reached, the method 400 includes determining to switch from the two-step RACH procedure to the four-step RACH procedure. In some embodiments, when the UE 10 switches to the four-step RACH procedure, the method 400 includes transmitting a message associated with the four-step RACH procedure using an original calculated transmission power, a current transmission power, or an increased transmission power. In some embodiments, the method 400 includes receiving, from the network node 20, configured different uplink transmission power transmission parameters for the two-step RACH procedure and the four-step RACH procedure respectively, and the configured different uplink transmission power transmission parameters for the two-step RACH procedure and the four-step RACH procedure include a preamble received target power and a power ramping step. In some embodiments, the method 400 includes calculating transmission powers of the message associated with the two-step RACH procedure and the message associated with the four-step RACH procedure separately, and the transmission powers of the message associated with the two-step RACH procedure and the message associated with the four-step RACH procedure are different.

In some embodiments, the method 400 includes selecting to switch from the two-step RACH procedure to the four-step RACH procedure at any time during a transmission of the message associated with the two-step RACH procedure. In some embodiments, even if a maximum retransmission of the message associated with the two-step RACH procedure is not reached, the method 400 includes selecting to switch from the two-step RACH procedure to the four-step RACH procedure. In some embodiments, the method includes selecting to switch from the two-step RACH procedure to the four-step RACH procedure based on a transmission power of the message associated with the two-step RACH procedure.

In some embodiments, when a maximum transmission power of the message associated with the two-step RACH procedure is reached, the method 400 includes selecting to switch from the two-step RACH procedure to the four-step RACH procedure. In some embodiments, the method 400 includes determining to use the two-step RACH procedure or the four-step RACH procedure based on a reference signal received power (RSRP) and/or pathloss of the UE 10 or by evaluating a radio frequency (RF) condition of the UE 10.

In some embodiments, in the two-step RACH procedure, if the UE 10 does not receive the message 2 from the network node 10 after sending the message 1, the UE 10 will increase transmit power and re-try the message 1. The UE 10 keep ramping up the transmit power until the maximum re-transmission is reached. After that, the UE 10 claims a RACH failure and reports the RACH failure to an RRC layer. For example, if the initial UE transmission (Tx) power for the message 1 is x dBm, power ramping step is 2 dB, and the maximum re-transmission counter is 3, then Tx power for a first transmission of the message 1 is x dBm, Tx power for a second transmission of the message 1 is x+2 dBm, and Tx power for a third (final) transmission of the message 1 is x+4 dBm.

In some embodiments, when the two-step RACH procedure is introduced, the similar power ramping up and RACH failure mechanism can also be applied. Since the message A in the two-step RACH procedure includes contents of the message 1 and the message 3, it may suffer smaller UL coverage than the message 1 in the four-step RACH procedure. When the UE 10 chooses to use the two-step RACH procedure, the message A may not reach to the network node 20. In this case, it's not desired and optimized for the UE 10 to claim a RACH failure after maximum re-transmission of the message A. It's necessary to introduce a mechanism to let the UE re-try the four-step RACH procedure.

To help the UE 10 determine the Tx power of RACH, the network node 20 includes IE “preambleReceivedTargetPower” in system information. This is an expected received power by the network node 20 for the message A or the message 1. Based on preambleReceivedTargetPower and UE measured pathloss, the UE 10 can calculate a required Tx power for the message A or the message 1. For re-transmission, power ramping parameter is given by “powerRampingStep”.

In some embodiments, after the UE 10 reaches the maximum retransmission of the message A of the two-step RACH procedure, the UE shall not claim RACH failure. Instead, the

UE shall fall back to the four-step RACH procedure for a re-try.

In some embodiments, when falling back to the four-step RACH procedure, the UE 10 goes back to the original calculated Tx power. In the embodiment, assume the UE 10 has the same configuration as described: initial Tx power of x dBm, power ramping step of 2 dBm, and max re-Tx of 3, then the fallback mechanism is as follows.

Tx power for 1st transmission of the message A for the two-step RACH procedure: x dBm, Tx power for 2nd transmission of the message A for the two-step RACH procedure: x+2 dBm, Tx power for 3rd transmission of the message A for the two-step RACH procedure: x+4 dBm, Tx power for 1st transmission of the message 1 for the four-step RACH procedure: x dBm, Tx power for 2nd transmission of the message 1 for the four-step RACH procedure: x+2 dBm, Tx power for 3rd transmission of the message 1 for the four-step RACH procedure: x+4 dBm, and if all above fails, the UE 10 claims RACH failure.

In some embodiments, when falling back to the four-step RACH procedure, the UE 10 stays at the current Tx power. In the embodiment, the fallback mechanism is as follows.

Tx power for 1st transmission of the message A for the two-step RACH procedure: x dBm, Tx power for 2nd transmission of the message A for the two-step RACH procedure: x+2 dBm, Tx power for 3rd transmission of the message A for the two-step RACH procedure: x+4 dBm, Tx power for 1st transmission of the message 1 for the four-step RACH procedure: x+4 dBm (here the UE 10 stays at the existing Tx power), Tx power for 2nd transmission of the message 1 for the four-step RACH procedure: x+6 dBm, Tx power for 3rd transmission of the message 1 for the four-step RACH procedure: x+8 dBm, and if all above fails, the UE 10 claims RACH failure.

In some embodiments, when falling back to the four-step RACH procedure, the UE 10 continues power ramping. In the embodiment, the fallback mechanism is as follows.

Tx power for 1st transmission of the message A for the two-step RACH procedure: x dBm, Tx power for 2nd transmission of the message A for the two-step RACH procedure: x+2 dBm, Tx power for 3rd transmission of the message A for the two-step RACH procedure: x+4 dBm, Tx power for 1st transmission of the message 1 for the four-step RACH procedure: x+6 dBm (here the UE 10 continues power ramping), Tx power for 2nd transmission of the message 1 for the four-step RACH procedure: x+8 dBm, Tx power for 3rd transmission of the message 1 for the four-step RACH procedure: x+10 dBm, and if all above fails, the UE 10 claims RACH failure.

In some embodiments, the network node 20 provides different values of “preambleReceivedTargetPower” for the two-step RACH procedure and four-step RACH procedure. The UE 10 calculates Tx power of the two-step RACH procedure and the four-step

RACH procedure separately. The network node 20 may also provide different configurations of “powerRampingStep” and other RACH related parameters for the two-step RACH procedure and the four-step RACH procedure. In the embodiment, assume the initial calculated Tx power for two-step RACH procedure is x1 dBm and Tx power for the four-step RACH procedure is x2 dBm, the fallback mechanism is as follows.

Tx power for 1st transmission of the message A for the two-step RACH procedure: x1 dBm, Tx power for 2nd transmission of the message A for the two-step RACH procedure: x1+2 dBm, Tx power for 3rd transmission of the message A for the two-step RACH procedure: x1+4 dBm, Tx power for 1st transmission of the message 1 for the four-step RACH procedure: x2 dBm, Tx power for 2nd transmission of the message 1 for the four-step RACH procedure: x2+2 dBm, Tx power for 3rd transmission of the message 1 for the four-step RACH procedure: x2+4 dBm, and if all above fails, the UE 10 claims RACH failure.

In some embodiments, the UE can select to fall back to the four-step RACH procedure at any time during the message A transmission in the two-step RACH procedure. In the embodiment, the UE 10 can determine to switch to use the four-step RACH procedure even if the maximum re-transmission of the message A is not reached. In this case, the UE can use initial Tx power to transmit the message 1 of the four-step RACH procedure. Tx power for 1st Tx of the message A: x dBm. Tx power for 2nd Tx of the message A: x+2 dBm. The UE decides fallback. Tx power for 1st Tx of the message 1: x dBm. Tx power for 2nd Tx of the message 1: x+2 dBm. Stay on the current Tx power to transmit the message 1 of the four-step RACH procedure. Tx power for 1st Tx of the message A: x dBm. Tx power for 2nd Tx of the message A: x+2 dBm. The UE 10 decides fallback. Tx power for 1st Tx of the message 1: x+2 dBm. Tx power for 2nd Tx of the message 1: x+4 dBm. Continue power ramping and use the new calculated Tx power for the message 1. Tx power for 1st Tx of the message A: x dBm. Tx power for 2nd Tx of the message A: x+2 dBm. The UE 10 decides fallback. Tx power for 1st Tx of the message 1: x+4 dBm. Tx power for 2nd Tx of the message 1: x+6 dBm.

In some embodiments, the UE 10 can select to fall back to the four-step RACH procedure based on UL Tx power used on the message A. In the embodiment, the UE 10 can decide to switch to use the four-step RACH procedure when reaching a pre-defined maximum Tx power of the message A. Tx power for 1st Tx of the message A: x dBm. Tx power for 2nd Tx of the message A: x+2dBm. Now the pre-defined maximum Tx power of the message A is reached. Tx power for 1st Tx of the message 1: x dBm (use initial Tx power), x+2 dBm (use the current Tx power), or x+4 dBm (continue power ramping).

In some embodiments, based on existing RSRP and/or pathloss, the UE 10 determines to use the two-step RACH procedure or the four-step RACH procedure.

In some embodiments, the UE 10 can evaluate existing RF condition to determine to use four-step or the four-step RACH procedure.

FIG. 5 is a block diagram of an example system 700 for wireless communication according to an embodiment of the present disclosure. Embodiments described herein may be implemented into the system using any suitably configured hardware and/or software. FIG. 5 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shilling, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

In the embodiment of the present disclosure, a user equipment (UE) and a method for a faster and more efficient RACH procedure of same capable of providing high reliability are provided. The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment (UE), comprising:
a memory;
a transceiver; and
a processor coupled to the memory and the transceiver,
wherein the processor is configured to:
initiate a two-step random access channel (RACH) procedure;
control the transceiver to transmit a first message, wherein the first message is associated with the two-step RACH procedure; and
determine to switch from the two-step RACH procedure to a four-step RACH procedure, wherein the determining is based on transmission information of the first message.

2. The UE of claim 1, wherein after a maximum retransmission of the first message is reached, the processor determines to switch from the two-step RACH procedure to the four-step RACH procedure.

3. The UE of claim 2, wherein in response to switching to the four-step RACH procedure, the transceiver transmits a second message, wherein the second message is associated with the four-step RACH procedure.

4. The UE of claim 3, wherein the transceiver transmitting a second message comprises: the transceiver transmits a second message using an original calculated transmission power, a current transmission power, or an increased transmission power.

5. The UE of claim 2, wherein the transceiver is configured to receive, from a network node, a configured first uplink transmission power transmission parameter for the two-step RACH, wherein the first uplink transmission power transmission parameter comprises a first preamble received target power and a first power ramping step; and
the processor is configured to calculate a first transmission power of the first message according to the first uplink transmission power transmission parameter.

6. The UE of claim 2, wherein the transceiver is configured to receive, from a network node, a configured second uplink transmission power transmission parameter for the four-step RACH, wherein the second uplink transmission power transmission parameter comprises a second preamble received target power and a second power ramping step; and
the processor is configured to calculate a second transmission power of the second message according to the second uplink transmission power transmission parameter.

7. The UE of claim 1, wherein the processor is configured to determine to use the two-step RACH procedure or the four-step RACH procedure based on a reference signal received power (RSRP) and/or pathloss of the UE.

8. The UE of claim 1, wherein the first message is a message A.

9. The UE of claim 3, wherein the second message is a message 1.

10. The UE of claim 1, wherein the processor is configured to determine to switch from the two-step RACH procedure to the four-step RACH procedure at any time during a transmission of the first message.

11. A method for a random access channel (RACH) procedure of a user equipment (UE), comprising:
initiating a two-step RACH procedure;
transmitting a first message, wherein the first message is associated with the two-step RACH procedure; and
determining to switch from the two-step RACH procedure to a four-step RACH procedure, wherein the determining is based on transmission information of the first message.

12. The method of claim 11, wherein after a maximum retransmission of the first message is reached, the method comprises determining to switch from the two-step RACH procedure to the four-step RACH procedure.

13. The method of claim 12, wherein when the UE switches to the four-step RACH procedure, the method comprises transmitting a second message, wherein the second message is associated with the four-step RACH procedure.

14. The method of claim 13, wherein the transmitting a second message comprises: transmitting the second message using an original calculated transmission power, a current transmission power, or an increased transmission power.

15. The method of claim 12, wherein the method comprises:
receiving, from a network node, a configured first uplink transmission power transmission parameter for the two-step RACH, wherein the first uplink transmission power transmission parameter comprises a first preamble received target power and a first power ramping step; and
calculating a first transmission power of the first message according to the first uplink transmission power transmission parameter.

16. The method of claim 12, wherein the method comprises receiving, from a network node, a configured second uplink transmission power transmission parameter for the four-step RACH, wherein the second uplink transmission power transmission parameter comprises a second preamble received target power and a second power ramping step; and
calculating a second transmission power of the second message according to the second uplink transmission power transmission parameter.

17. The method of claim 11, wherein the method comprises determining to use the two-step RACH procedure or the four-step RACH procedure based on a reference signal received power (RSRP) and/or pathloss of the UE.

18. The method of claim 11, wherein the first message is a message A.

19. The method of claim 13, wherein the second message is a message 1.

20. A non-transitory machine-readable storage medium having stored thereon instructions that, when executed by a computer, cause the computer to perform the method of claim 11.
